(19) United States
(12) Patent Application Publication
(10) Pub. No.: US 2004/0073458 A1
(43) Pub. Date: Apr. 15, 2004

(54) Method and system for processing medical records

(75) Inventor: David H. Jensen, Bountiful, UT (US)

Correspondence Address: Steve M. Perry, THORPE NORTH & WESTERN, LLP, P.O. Box 1219, Sandy, UT, 84091-1219, US

(73) Assignee: Aviacode Inc.

(21) Appl. No.: 10/630,328

(22) Filed: Jul. 30, 2003

Related U.S. Application Data
(60) Provisional application No. 60/400,217, filed on Jul. 31, 2002.

(51) Int. Cl. G06F 17/60; G06F 15/16

(52) U.S. Cl. 705/2; 709/201

(57) ABSTRACT

A method is provided for processing medical documentation for a health care provider. The method includes the step of receiving a medical source document for a health care provider into a hosting server enabled to receive the medical source document. Another step is enabling a medical documentation hander to access the medical source document on the hosting server via a computer network coupled to the hosting server. A further step is facilitating the electronic creation of processed medical data based on the medical source document analyzed by a medical documentation hander. An additional step is transmitting the processed medical data to the health care provider.

This non-provisional application claims priority to U.S. application Ser. No. 60/400,217 filed on Jul. 31, 2002.

### FIELD OF THE INVENTION

The present invention relates generally to processing medical records.

### BACKGROUND

Medical codes or clinical data representations are numerical classifications or labels that are widely used to document medical diagnoses, procedures, and test results. There are more than 150 known coding systems but four or five of those have obtained the widest acceptance in the United States. ICD-9 coding is a coding system with more than fifty thousand codes used to represent diagnostic codes, and the system is maintained by the World Health Organization. CPT codes are maintained by the American Medical Association for reimbursement and utilization review purposes. CPT is a scheme of codes that represent the various medical procedures. Two other widely used coding systems are the SNOWMED system for describing pathological test results and the HPCPS codes for coding relating to the anatomy. The HPCPS system includes fifteen thousand codes.

For the health care industry, accurate coding is very important because inaccurate coding can be extremely costly for health care providers and has even driven a few medical practices into bankruptcy. The medical coding process typically follows a specific pattern. When a doctor is finished with a patient, the doctor picks up a phone or a recording device and dictates information about the patient's visit. The doctor may describe a problem and the health condition of the patient, and then to explain what he or she did to treat and care for the patient. A transcriptionist then listens to the doctor's dictation and types the narration into the written document that becomes the medical transcription document.

The medical transcription document or scanned medical source document can then be coded. A medical coder or medical document handler reads the medical transcription document or medical source document and interprets it according to the rules that govern the thousands of codes in the coding system being used. A primary reason for codes is that it forms a basis from which the doctor will be paid. The codes can also be used by governmental health organizations for statistical purposes.

Additionally, medical codes are used by insurance carriers to determine the nature of the problem, why the patient visited the health care provider and to assess what the doctor did to care for the patient. Doctors are paid by the insurance carriers according to what the doctor did for the patient. A simple routine office visit generally pays the lowest amount on the payment scale. If it is an emergency case where the patient is rushed into the emergency room, or if it is a much more complex case, the insurance carrier will pay a much higher rate.

Accurate medical coding is important because if a health care provider codes a service too high or too low, or if their documentation does not support what they have coded, the doctor or medical service provider can be fined and be liable for treble damages. For example, an orthopedic surgeon performing a hundred knee scopes per year is at risk for $10,000 per incident for cases that are coded incorrectly. This means there may be a liability of up to $1,000,000. The government can also look at previous years and extrapolate the liability over a number of years and then the risk of fines and penalties can be treble the base amount.

In addition to the liability issues, medical coders are essential in ensuring a healthy bottom line for medical businesses. As the first step in the revenue cycle, medical coders directly impact billing, reimbursement and accounts receivable. The faster documents are able to be coded, the more timely a return can be provided to the health care provider. When coding is not done in a timely manner, medical charts remain uncoded, discharge-not final-bill days climb and revenue is left sitting on the table.

Currently, hospitals are suffering from a shortage of experienced, qualified clinical medical coders. In the same way that a nursing shortage negatively impacts the health of patients, the medical coder shortage negatively impacts the fiscal health of provider organizations. In addition to the uncoded charts and backlogs caused by coding vacancies, hospitals suffer from missed revenue opportunities when they used inexperienced coders. Replacing coders can also be costly to health care providers or management organizations. Thus, it is in health organizations best interests to provide the best tools available to medical coders and to provide the best coding conditions possible.

### SUMMARY

A method is provided for processing medical documentation for a health care provider. The method includes the step of receiving a medical source document for a health care provider into a hosting server enabled to receive the medical source document. Another step is enabling a medical documentation hander to access the medical source document on the hosting server via a computer network coupled to the hosting server. A further step is facilitating the electronic creation of processed medical data based on the medical source document analyzed by a medical documentation hander. An additional step is transmitting the processed medical data to the health care provider.

An additional embodiment of the invention provides a method for processing medical documentation for a health care provider. The method includes the step of receiving a medical source document for a health care provider into a hosting server enabled to receive the medical source document. A further step is enabling a medical coder to access the medical source document on the hosting server via a computer network coupled to the hosting server. An additional step is facilitating the electronic creation of coded medical information including encoded treatment procedures based on the medical source document as analyzed by the medical coder. Another step is transmitting the coded medical information to the health care provider.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is a block diagram of a system for processing medical records in accordance with an embodiment of the present invention;

FIG. 2 is flowchart of operations that can be performed in the system of FIG. 1 for medical coding; and

FIG. 3 is a flowchart of operations that can be performed in an embodiment of the invention for prioritizing medical source records;

FIG. 4 illustrates a portal window or page that the user or medical coder is presented after the user logs in;

FIG. 5 illustrates a work pool window that displays information about work in a selected work pool;

FIG. 6 illustrates a coding window where medical coding can be performed;

FIG. 7 illustrates a sample search using medical terms in an embodiment of the present invention;

FIG. 8 illustrates a window in the present invention that allows a coder to select terms that will be used in a search;

FIG. 9 illustrates a window where an advanced search can be provided;

FIG. 10 illustrates a window that can provide online resources such as a list of modifiers; and

FIG. 11 illustrates sample results from a code validation.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

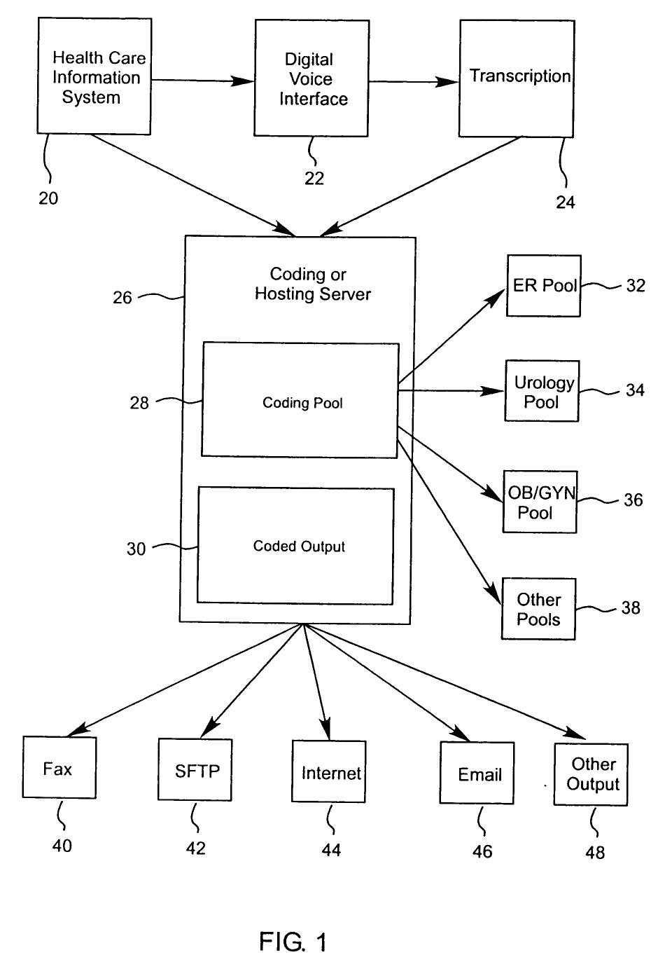

The present invention is a system and method for processing medical documentation as illustrated in FIG. 1. A coding server or hosting server 26 is provided and the server has electronic storage such as a hard drive, RAID array or network-attached-storage (NAS) to store the medical source documents received. Medical source documents are received through a plurality of electronic inputs configured to receive medical source documents for a health care provider. The medical source documents originate with the health care provider and the documents may be sent from a health care information system 20. Alternately, the medical source documents may pass through secondary service providers, such as a transcription service, before they reach the hosting server.

Medical source documents are typically medical records that are created when a doctor is finished with a patient and the doctor dictates information about the patient's visit. The medical source documentation may include the patient's problem, patient's condition and an explanation of the patient's care and treatment. This dictation can be stored in a digital voice interface 22 as an electronic file. Then this dictation can be sent to a transcriptionist or a transcription provider 24. The medical source documentation may also be scanned into the health care information system from a hard copy of the original medical record and then sent to the hosting server (not shown). There are additional ways of converting the dictation or medical record into a medical source document. These methods may include a direct telephone interface to the hosting server for dictations, electronically entered records by a doctor, a direct fax line in the hosting server, or similar methods of receiving medical source documentation.

Once the medical source documentation is received by the hosting server 26 the medical source documents are entered into a coding pool 28. The coding pool is divided into separate treatment or specialty pools by doctor specialty or subspecialty. FIG. 1 illustrates at least three possible specialty pools. For example, there may be an ER pool 32, Urology pool 34, OB/GYN pool 36 and there may be other specialty pools and subspecialty pools as needed by the coding system and the health care providers or doctors who are submitting information. A medical coder or medical document handler can then access the medical source documents in these separate pools. When a medical coder accesses the medical source documents, they view and read the documents. Then the medical coder determines which medical codes that represent a patient's care and treatment should be associated with the medical source document. The medical codes created by the medical coder are then saved in the hosting server based on the analysis by the medical coder.

The system and method of the present invention has the advantage that it does not actually download the medical source information to the medical coder's networked computer. In other words, the system does not provide the functionality to save the medical source documents to the local computer. Although the medical coder accesses these coding pools via a computer network such as the Internet or local area network or a wide area network, the information is actually stored on the hosting server 26. Once the information has been coded, the coded medical information is stored in a coded output area 30 in preparation to be transmitted to the health care provider. The coded medical information is transmitted to the health care provider based on the format selected by the health care provider and it may be associated with patient demographic information.

For example, the medical health care provider, hospital or doctor may request that the coded medical information be transmitted to them via fax 40, SFTP (secure file transfer protocol) 42, Internet 44, or Email 46. There are also other electronic methods that allow the coded information to be transmitted to the health care provider 48, and additional transmission methods can be used as they are developed. The plurality of electronic output channels are configured to transmit this coded medical information soon after it is created and it allows the health care provider to receive a quick turnaround and a high level of throughput with the electronic system.

Since the medical source documents are transferred to the hosting server electronically and then the completed coded medical information is transmitted electronically, these connections in the system consume just a short amount of the processing time. This is in contrast previous systems where the hard copy information for the medical source document was required to be viewed by the medical coder and the turnaround time for the coded information might take weeks.

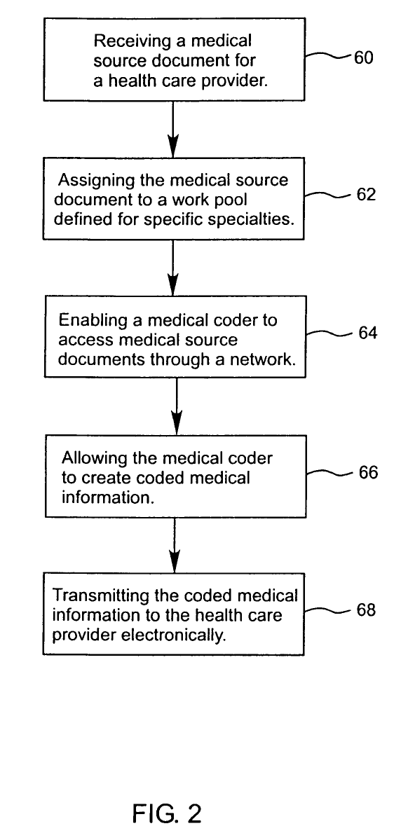

FIG. 2 illustrates a method for processing medical documentation for a health care provider. A system as in FIG. 1 can perform the operations as in the flowchart of FIG. 2. The first operation is receiving a medical source document for a health care provider into a hosting server that is enabled to receive the medical source document in block 60. Next, the medical source document is assigned to a specific work pool defined for specific treatment types or specialties in block 62. A medical coder is enabled to access the medical source document on the hosting server via the computer network coupled to the hosting server in block 64. The medical coder can access the medical source document on the hosting server via an application in a web browser via the Internet or through a health care provider application that is in communication with the hosting server.

Software used by the medical coder facilitates the electronic creation of coded medical information. The coded medical information includes encoded treatment procedures. The encoded treatment procedures are generated by the medical coder based on the medical source document in block 66. The medical coder analyzes the medical source document and generates these codes from one of the accepted medical coding systems such as ICD-9, CPT, HPCPS or SNOWMED. After the medical source document has been converted to coded medical information, the coded medical information can be transmitted to the health care provider-in block 68.

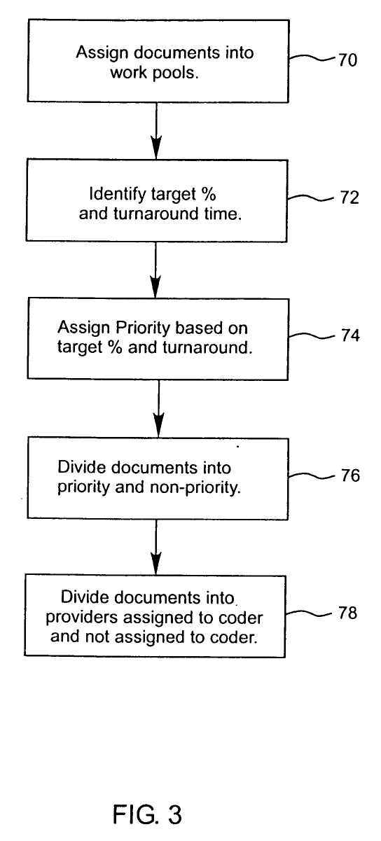

FIG. 3 illustrates a method for processing electronic medical source documentation received for a health care provider in a prioritized manner. The first operation is to assign documents into work pools in block 70. These work pools can be based upon medical specialties and subspecialties. Each of the medical source documents in a pool are further prioritized based on priority factors. The priority factors are the identified turnaround time, and the target percentage of documents that must be returned to a health care provider within that time. The turnaround time can be set at a certain number of days or hours as in block 72. Priorities are assigned to the documents based on the turnaround time required and the number of documents that must be turned around in that period, as in block 74. Within each queue, the documents are divided into priority and non-priority documents in block 76. Then the documents are divided into health care providers who are assigned to a medical coder and health care providers who are not assigned to a medical coder in block 78. In addition, the medical coder is then allowed to code the medical source document to create the coded medical information. The coded medical information is then transmitted to the health care provider.

The present invention can be implemented as an application service or Java application that resides on an Internet or network server. Accordingly, the terminology used within this description refers to a page, but such pages are database enabled and include scripted functions. Alternatively, the present invention may be implemented as a health care provider/server type of application where medical source documentation is viewed on a hosting server.

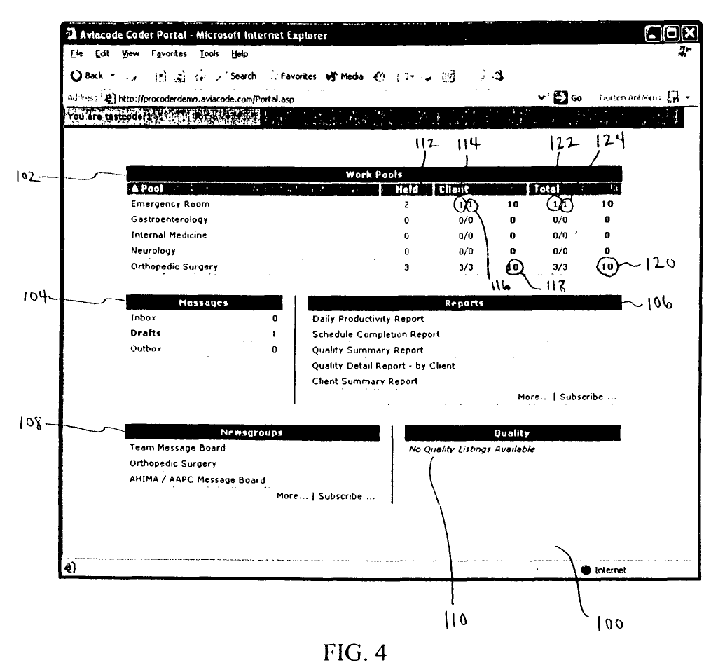

FIG. 4 illustrates an embodiment of portal page or initial window that the medical coder or medical document handler is presented after the medical coder log in. The page includes announcements, and other information that varies based on the access level and permissions of the user. From this page the medical coder or medical document handler can navigate to the work pools 102, check on correspondence 104, run reports 106, check newsgroup listings 108, check medical coding quality ratings 110, and view additional information. The portal page displays information regarding the work pools that can be used by the medical coder to decide which work pool to enter and work on. The medical coder will be able to decide which work pool to work on, and then the system will give the coder one transcription after another from that work pool. For each work pool, the following statistics may be displayed:

Number of Held (Suspended) documents (112)

Number of priority documents for assigned health care providers in the work pool (114)

Total number of documents for assigned health care providers in the work pool (116)

Priority score (0-10) for documents of assigned health care providers in the work pool (118)

Number of priority documents for all health care providers in the work pool (122)

Total number of documents for all health care providers in the work pool (124)

Priority score (0-10) for the documents of all health care providers in the work pool (120)

In particular, the work pool priority score provides a measure of the relative priority of work in each work pool. One possible formula for calculating the priority score uses numbers between 0 and 10:

Priority Designation=(x+¼ y+⅙ z) * 10, rounded to the nearest whole number. where,

X=number of priority documents divided by total number of documents.

Y=sum of priority field for priority documents divided by total number of documents.

Z=sum of priority field for non priority documents divided by total number of documents.

In the event the score is greater than 10, it is reset to 10. If less than 0, it is reset to 0. Of course, other number scales or priority calculations could be used based on the same underlying concepts.

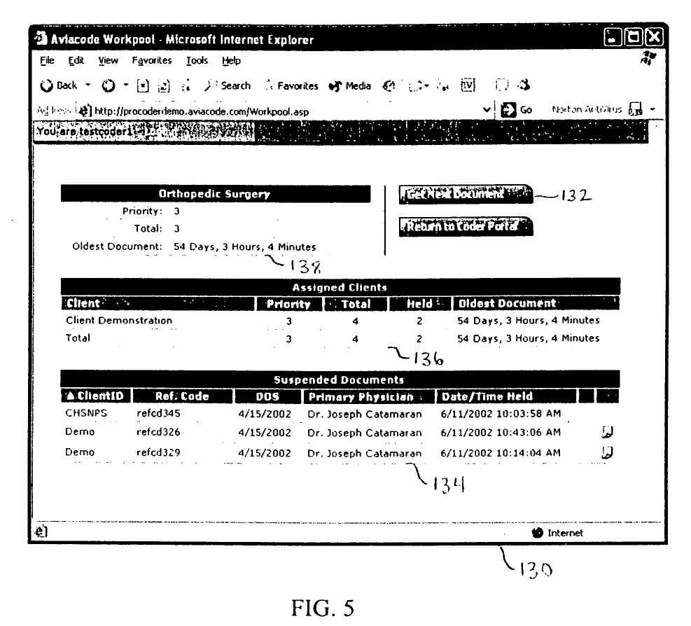

As depicted in FIG. 5, each work pool has a page 130 that displays more information about the work in a selected work pool. From a work pool page, the medical coder can select the next document 132, resume suspended documents 134, view assigned health care providers in the work pool 136, view a work pool summary 138, and perform similar functions.

Each medical source document is assigned to a work pool appropriate for the type of medical treatment described in the transcription, and a document is assigned to only one work pool (the document can be reassigned if necessary). Which work pool a transcription is assigned to is determined by the type of service performed and/or the primary physician's specialty or sub-specialty. In general, a separate work pool is defined for each medical specialty. Work pools can also be created that include more than one specialty or sub-specialty as needed. Each medical coder is authorized to work on one or more work pools, depending upon their qualifications. Some examples of work pools include: E & M, Family Practice, Pediatrics, OB/GYN (non-surgical), General Surgery, Podiatry, Cardiology, Radiology, Orthopedic Surgery, Psychology, Allergy/Immunology, etc.

Each work pool has an overall priority based on the priority of the transcriptions within that work pool. In other words, a total priority or average priority of the documents in to pool can determine the priority of the work pool. Each coder is assigned to one or more health care providers 136 that are also listed in the work pool window.

An advantage of this system is that there are significant efficiencies to be gained by having each coder assigned to particular health care providers. These efficiencies are based on learning the particular practices of individual medical health care providers or health care providers. For example, some medical health care providers may have non-standard, local codes they want used in place of the standard national codes. Others may use unusual abbreviations or terms in their transcriptions.

Selecting the Get Next Document button 132, in FIG. 5, will bring up the next medical source document from the selected work pool based on priority. Each medical source document has one of two priority states: normal (i.e., non-priority) and priority. When the priority value of a transcription rises to certain threshold (called the priority threshold), its state changes from normal to priority. This priority designation or priority value is recalculated every time a coder requests the next transcription. Each medical source document in a work pool can be categorized into one of at least four categories relative to the coder:

1. Priority documents from health care providers assigned to the coder.

2. Priority documents from health care providers not assigned to the coder.

3. Non-priority documents from health care providers assigned to the coder.

4. Non-priority documents from health care providers not assigned to the coder.

The system searches through each of these categories (within the selected work pool) in the above order until a medical source document is found. Within each category the documents are sorted by priority value, and are delivered to the medical coder in that order.

As discussed generally in FIG. 3, the priority of a document that the medical coder or medical document handler will work on is determined by a number of priority factors. The first of these factors is turnaround time. The number of hours between the time a transcription is submitted to the medical processing system until the time the coded medical information is due to be returned to the health care provider is called the turnaround hours or turnaround time.

An example turnaround goal may be a turnaround time for coding or processing of medical source documents within 24 hours or 48 hours. However, each health care provider may have a different turnaround time. The turnaround time is generally agreed to in a contract with the health care provider. However, turnaround time is used indirectly in the determination of priority, and it is used to calculate the number of hours before the transcription is due, which is in turn used to calculate the priority.

The second priority factor is a target percentage. An example of a target percentage is that the goal for a health care provider may be to have more than 95% of the medical source documents coded before the turnaround time or deadline. The target percentage can be measured per health care provider. This percentage is generally agreed to in a contract with the health care provider. Each health care provider may have a different percentage as the goal, so the system must allow the relative priority of transcriptions from various health care providers to reflect the target percentage. For example, a transcription due in 8 hours from a health care provider with a target percentage of 99% needs to have a higher priority than a transcription due in 8 hours from a health care provider with a target percentage of 95%.

Target percentages and turnaround times are two variables that are used in the present system and method to define the relative priority of one health care provider's medical source documents compared to other health care providers. As such, the system uses these two variables as the prime determinants of each transcript's priority. Other factors can be also used to determine priorities such as the cumulative age of a group of medical source documents or the importance of a specific health care provider.

The present invention provides the advantage of grouping medical source documents into specific work pools. One advantage is the efficiency created by working with batches of similar medical source documents. For example, if there are 10 Family Practice transcriptions to code and 10 Orthopedic Surgery transcriptions to code, then it is more efficient for a medical coder to code all the Family Practice transcriptions and then all of the Orthopedic Surgery transcriptions (or vice versa) rather than coding these 20 transcriptions in a random order. Medical source documents can also be prioritized in batches to increase the efficiency of the medical coder.

Although the document or batch priorities are generally assigned by the automated methods described, there are workflow situations that are better handled by human judgment than by a prioritization system. Accordingly, the operations managers are able to manually override the automated priorities in order to re-route medical source documents and transcriptions to particular medical coders as system managers deem appropriate.

Prioritizing medical source documents based on time relative to the priority threshold, and having each coder work first on priority transcriptions before working on non-priority transcriptions encourages the timely completion of medical coding. The work pool priority metric provides each coder with valuable information in deciding which work pool to work on. Furthermore, allowing each coder to work on priority transcriptions from health care providers to whom he is not assigned tends to increase the number of coders working on priority transcriptions during peak times. Since the coder can select the work pool to work on, rather than having medical source documents delivered to the coder in a simple priority order, this system allows the coder to work on batches of similar transcriptions.

Referring again to FIG. 5, a medical coder is allowed to suspend medical source documents 134 where there are questions or outstanding issues. The coder can save the coding done so far at any time by suspending the current document. When a document is suspended, the coding done so far is saved in the database. The coding can be saved in an XML block or some other database record in the database. A coder's suspended documents are listed on the coder's work pool page, and the number of documents they have suspended can be shown for each work pool on the coder's portal page. The coder can resume coding of these medical source documents at any time via their work pool page.

Now the overall system and the medical source document prioritization system have been discussed, an embodiment of the invention for enabling medical coders or medical document handlers to code medical source documents will be described. This embodiment of the invention is significant because it links the presentation of a medical source document to a medical coder together with the coding of the medical source document. This allows the medical coder to code a document with patent treatment codes more quickly and accurately.

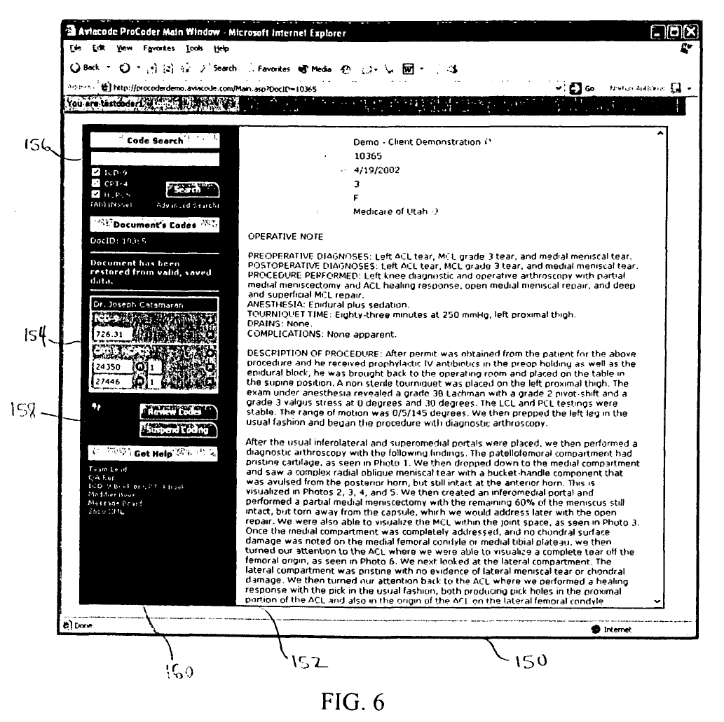

FIG. 6 illustrates a coding window 150 where the actual medical coding is done. This page allows the coders to see the medical source document 152 (e.g., for a medical service) and enter codes associated with the medical source document 154. The medical coder can also search for codes based on the content of the medical source document or criteria specified by the coder 156, review and validate codes 158, and submit the coded document for transmission to the health care provider.

In this embodiment, the text and/or scanned image of the medical source document is on the right 152, and the coding tools are on the left 160. The left side of the page or window includes a code search, list of physicians, and codes assigned to the medical source document (organized by physician). This window also includes the ability to review codes, ask the doctor a question about the transcription, etc.

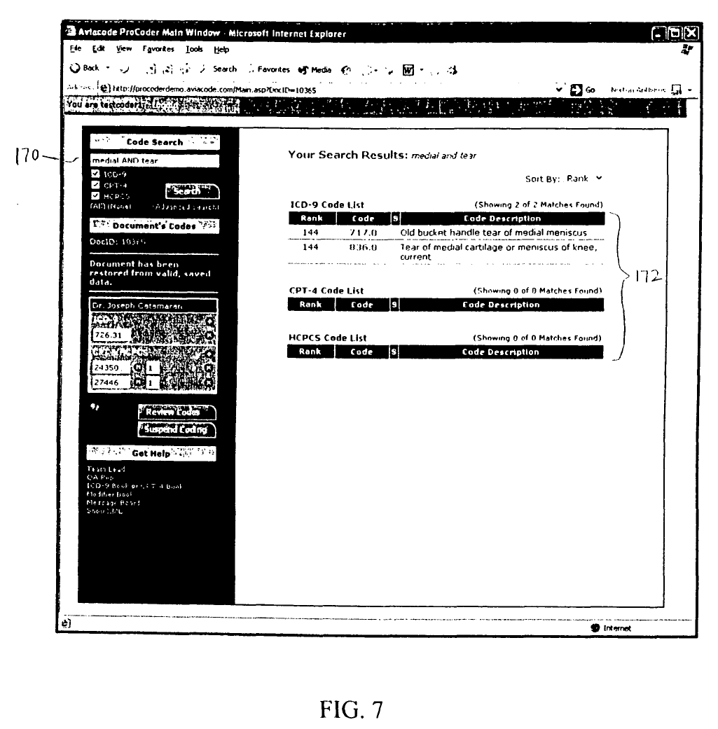

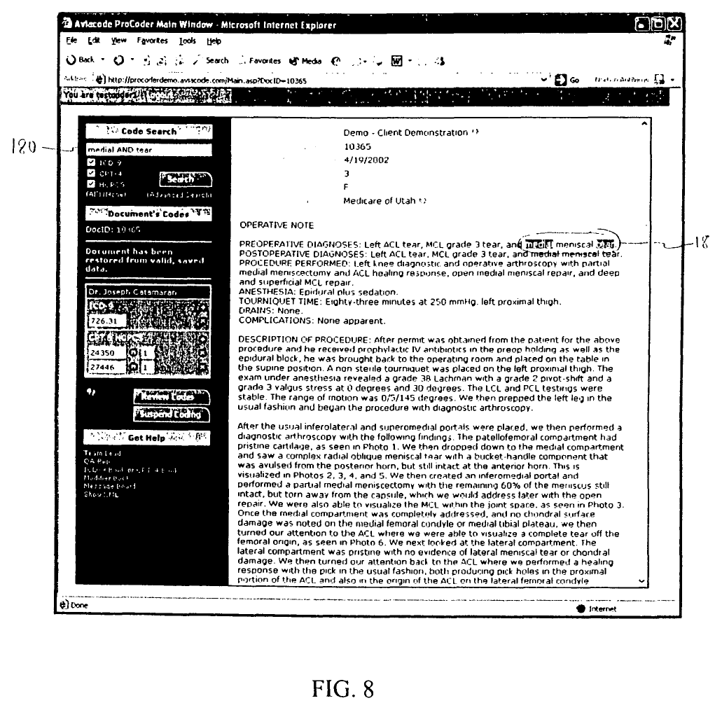

FIG. 7 illustrates a sample of a search in the present system for codes that include both “medial” and “tear” 170. These search results are grouped by code system type 172 (i.e., ICD-9, CPT, HCPCS), and can be sorted by either search hit rank or code. FIG. 8 depicts another valuable feature of the present invention that allows a coder to select terms that will be used in a search. The search terms can be identified either by typing the desired search terms directly into the code search field 180, or by clicking on or selecting any of the words in the body of the medical source document 182.

When the medical terminology is selected or clicked on then the terms are copied or entered into the search list. This is useful because it is time consuming for a medical coder to have to re-type medical terms into the search window and errors can also be introduced in typing. This invention also avoids the slow and repetitive process of cut-and-paste for the search window. Automated copying of the medical terms aids the medical coder in using the search features of the present invention. A medical coder is more likely to return accurate results if they use the searching feature, and using the searching feature is much faster than it would otherwise be because the coder can directly enter medical terms into the search box just by clicking on the words.

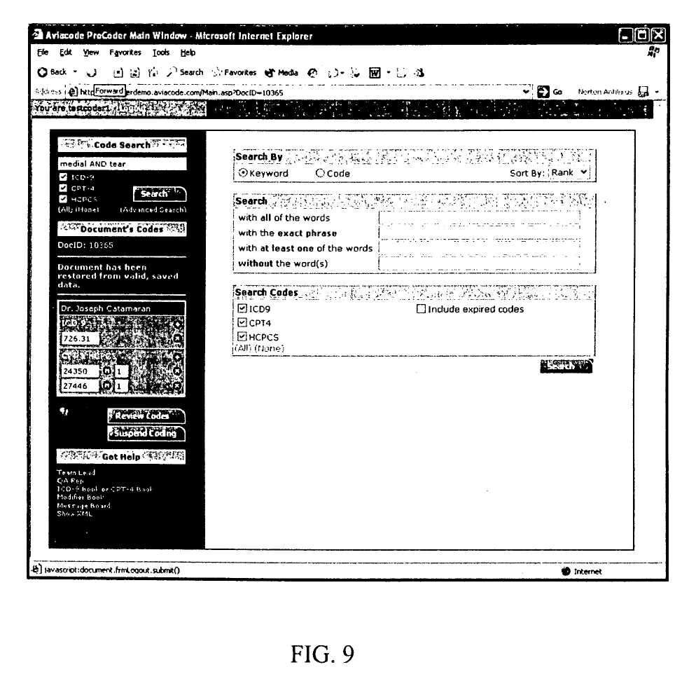

In addition to the standard search, an advanced search can be provided. This is illustrated in FIG. 9. Its output is in the same format as the standard search. The advanced search allows specific types of searches to take place such as exact phrase searches, a search without specified words, Boolean searches, or other more detailed searches. Results from either search can be clicked on in order to add them to the coding list on the left side of the page.

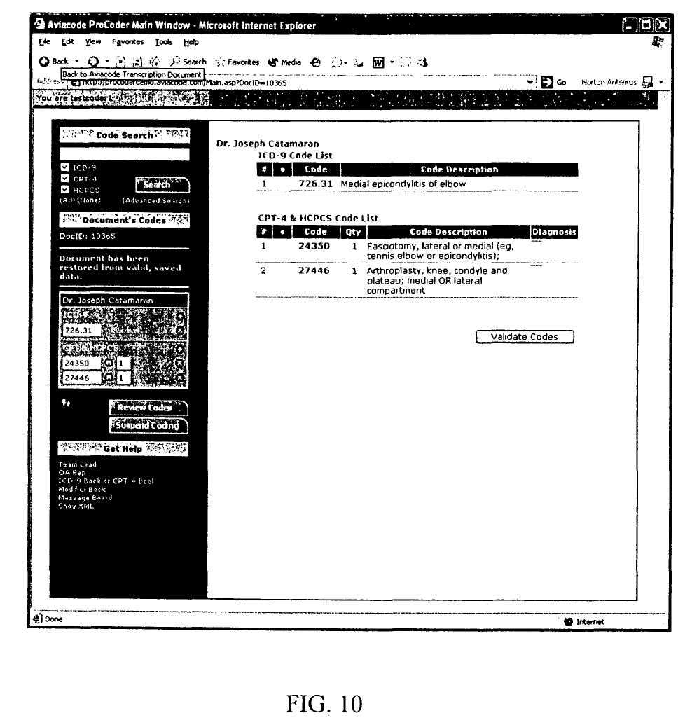

In addition to the search capabilities, the present system also provides online resources such as the list of modifiers shown in FIG. 10. The search system can also include searchable online books of medical codes.

As described in the work pool page discussion, the coder can suspend coding of the medical source document at any time by selecting the suspend coding button in the coding window. This allows medical coders to ask questions regarding a document. These questions are sent to the primary physician or an authorized representative within the health services provider. Included in the question can be a link to a document that allows the physician to electronically review the document and respond. These questions or information requests are sent through the medical processing system, so they are secure and controlled by access checks. It is also efficient and fast for the doctors to respond to the electronic questions.

Coding validation is another part of the present invention. Coding validation involves at least two checks. The first of these checks is an automated code review, which checks the validity of the codes themselves. This means that the codes entered by the medical coder are checked to determine that the codes actually exist within one of the accepted medical coding systems. The second part is validating codes. Validating checks the validity of the coding. This validity check can include checking the validity of the combination of codes used relative to the patient's demographic data, the insurance carrier's policies, etc. Validation can also check to determine that the codes used are from the same or similar specialties. This prevents disparate codes from being entered when the codes are clearly out of place based on the other codes entered or the work pool being worked on.

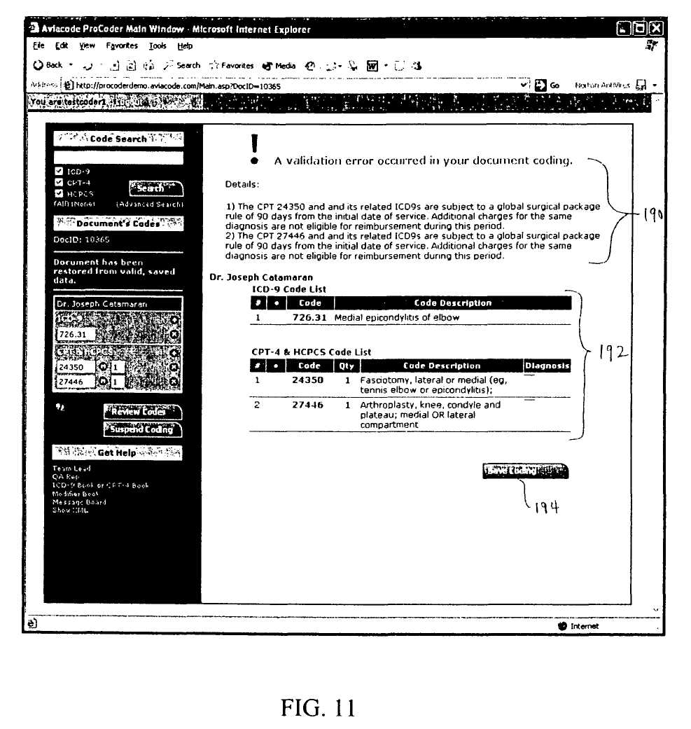

FIG. 11 illustrates sample results from a code validation. This example error message 190 can be generated by the second part of the coding validation. Note that this example shows the system catching an invalid coding. An error message is displayed to inform the coder that there appears to be a problem. The window can also display the codes in question 192 so that the medical coder can read the description of the codes and determine what has created the conflict. When the codes are ready, the medical coder simply activates the save coding button 194 to submit the coding for transmission to the health care provider.

The present system provides authorized users access to reports. Authorized users will have access to pre-determined reports based on their permissions to generate reports for particular health care providers, etc. These reports can be generated and sent out automatically according to a schedule, or generated as needed. Custom reports for health care providers can also be generated.

The system and method for processing medical records uses security to protect sensitive information. For example, the network communications can use the industry standard Secure Socket Layer (SSL) at its highest available encryption level (i.e., 128-bit) to ensure the integrity and privacy of the information transmitted between the coding system or hosting server and the medical coders, business partners, health care service providers, and health care providers.

Each window or page of the application can check the access level and permissions of the user before it is displayed. In addition, the medical coders preferably access the system only from secure locations. Personally identifiable information is not generally included in the coding window to protect patient identity. The coders are given enough information to code the transcription, but not enough to identify the patient.

The present invention can also be used by a medical document handler to process numerous types of documents in addition to just medical source documents that need to be coded. Other types of medical source documents that can be processed are accounts receivable documents, lab results, medical equipment purchase orders, and similar types of medical documents. In other words, the present invention can be applied to medical source documents that need to be processed and possibly have some code associated with them.

It is to be understood that the above-referenced arrangements are illustrative of the application for the principles of the present invention. Numerous modifications and alternative arrangements can be devised without departing from the spirit and scope of the present invention while the present invention has been shown in the drawings and described above in connection with the exemplary embodiments(s) of the invention. It will be apparent to those of ordinary skill in the art that numerous modifications can be made without departing from the principles and concepts of the invention as set forth in the claims.

What is claimed is:

1. A method for processing medical documentation for a health care provider, comprising the steps of:
receiving a medical source document for a health care provider;
assigning the medical source document to a work queue defined for specific medical treatment types; and
enabling a medical coder to access the medical source document in the work queue through a computer network;
allowing the medical coder to electronically code the medical source document to create coded medical information; and
transmitting the coded medical information including encoded treatment procedures to the health care provider electronically.

2. A method as in claim 1, further comprising the step of creating coded medical information by enabling the medical coder to extract information from the medical source document.

3. A method as in claim 1, wherein the step of transmitting the coded medical information to the health care provider further comprises the step of transmitting the coded medical information to the health care provider via an electronic communication means selected from the group of electronic communication means consisting of a fax, secure file transfer protocol (FTP), a web browser and email.

4. A method as in claim 1, wherein the step of enabling a medical coder to access the medical source document in the work queue through a computer network further comprises the step of enabling a medical coder to access the medical source document via a computer network that is a local area network (LAN), wide area network (WAN), or Internet.

5. A method for processing medical documentation for a health care provider, comprising the steps of:
receiving a medical source document for a health care provider into a hosting server enabled to receive the medical source document;
enabling a medical coder to access the medical source document on the hosting server via a computer network coupled to the hosting server;
facilitating the electronic creation of coded medical information including encoded treatment procedures based on the medical source document as analyzed by the medical coder; and
transmitting the coded medical information to the health care provider.

6. A method as in claim 5, further comprising the step of enabling the medical coder to access the medical source document on the hosting server via a network selected from the group of networks consisting of a local area network (LAN), wide area network (WAN), and Internet.

7. A method as in claim 5, further comprising the step of distributing medical source documents to the medical coder using a plurality of categorized work pools.

8. A method as in claim 7, further comprising the step of distributing medical source documents to the medical coder using a plurality of prioritized work queues.

9. A method as in claim 5, wherein the step of enabling a medical coder to access the medical source document further comprises the step of distributing medical source documents to a plurality of medical coders via a computer network coupled to the hosting server to allow conversion of the medical source documents to coded medical information.

10. A method for processing medical documentation for a health care provider, comprising the steps of:
receiving a medical source document for a health care provider into a hosting server enabled to receive the medical source document;
enabling a medical documentation hander to access the medical source document on the hosting server via a computer network coupled to the hosting server;
facilitating the electronic creation of processed medical data based on the medical source document analyzed by a medical documentation hander; and
transmitting the processed medical data to the health care provider.

11. A method as in claim 10, further comprising the step of restricting the medical documentation hander from being able to save the medical source document on a local computer.

12. A method as in claim 10 further comprising the step of retaining the medical source document on the hosting server while enabling the medical documentation hander to process the medical source document on a local computer.

13. A method as in claim 10, wherein the step of facilitating the electronic creation of processed medical data further comprises the step of facilitating the electronic creation of coded medical information that includes coded medical billing information.

14. A medical documentation processing system, comprising:
a plurality of electronic inputs configured to receive medical source documents for a health care provider;
a coding server, coupled to the electronic inputs, having electronic storage to store the medical source documents received; and
a plurality of coding queues within the coding server to which the medical source documents are assigned and through which a medical coder can access the medical source documents and create coded medical information from the medical source document;
a plurality of electronic output channels configured to transmit the coded medical information to the health care provider.

15. A device in accordance with claim 14, wherein the electronic output channels are selected from the group of electronic output channels consisting of a fax, a secure file transfer protocol (FTP), a web browser and email.

16. A device in accordance with claim 14, wherein medical source documents are assigned to the plurality of coding queues based on a priority value assigned to the medical source documents.

17. A method for processing medical documentation for health care providers, comprising the steps of:
receiving a treatment record from a health care service provider;
converting the treatment record to a medical source document;
assigning the medical source document to a work queue defined for a specific medical specialty; and
enabling a medical coder to access the medical source document in the work queue through a computer network;
allowing the medical coder to code the medical source document which creates coded medical information; and
transmitting the coded medical information to the health care service provider.

18. A method as in claim 17, wherein the step of converting the treatment record to a medical source document further comprises the step of transcribing the treatment record into a medical source document.

19. A method as in claim 17, wherein the step of converting the treatment record to a medical source document further comprises the step of scanning the treatment record into a medical source document.

20. A method for processing electronic medical source documentation received for a health care provider, comprising the steps of:
assigning the electronic medical source document to a work pool defined for specific medical treatment types;
prioritizing the electronic medical source document for further processing based on priority factors;
enabling a medical coder to access the electronic medical source document accompanied by a priority designation in the work queue through a computer network;
allowing the medical coder to code the medical source document to create coded medical information; and
transmitting the coded medical information to the health care provider.

21. A method as in claim 20, wherein the step of assigning the electronic medical source document to a work pool defined for specific medical treatment types further comprises the step of assigning the electronic medical source document to a work pool defined for medical specialties or sub-specialties.

22. A method as in claim 20, further comprising the step of dividing the electronic medical source documents into a plurality of work queues.

23. A method as in claim 22, further comprising the step of prioritizing the electronic medical source document in a work queue based on the remaining turnaround time available.

24. A method as in claim 22, further comprising the step of prioritizing the electronic medical source document in a work queue based on the percentage of coded medical information that is to be coded before a defined deadline.

25. A method as in claim 22, further comprising the step of organizing the electronic medical source documents into batches in a work queue and then prioritizing the batches to allow for efficient coding.

26. A method as in claim 22, further comprising the step of dividing the electronic medical source documents into priority electronic medical source documents from health care providers and non-priority electronic medical source documents from health care providers.

27. A method as in claim 26, further comprising the step of dividing the electronic medical source documents into priority electronic medical source documents from health care providers assigned to the medical coder and priority electronic medical source documents from health care provides not assigned to the medical coder.

28. A method as in claim 27, further comprising the step of dividing the electronic medical source documents into non-priority electronic medical source documents from health care providers assigned to the medical coder and non-priority electronic medical source documents from health care providers not assigned to the medical coder.

29. A medical records processing system, comprising:
a plurality of electronic inputs configured to receive a medical source document for a health care provider;
a hosting server, coupled to the electronic inputs, having electronic storage to store the medical source document received; and
a plurality of coding queues within the hosting server to which the medical source document is assigned based on a priority designation assigned to the medical source document;
a networked interface through which a medical coder can access the medical source document with the priority designation and create coded medical information from the medical source document;
a plurality of electronic output channels configured to transmit the coded medical information to the health care provider.

30. A system as in claim 29, wherein the electronic medical source documents are divided into a plurality of work pools based on specific medical treatment types.

31. A system as in claim 29, wherein the priority designation assigned to the medical source document is based on the remaining turnaround time available.

32. A system as in claim 29, wherein the priority designation assigned to the medical source document is based on the percentage of coded medical information that are to be coded before a pre-defined deadline.

33. A system as in claim 29, wherein electronic medical source documents are organized into batches in a work pool and the batches are prioritized to allow for efficient coding.

34. A system as in claim 29, wherein the electronic medical source documents are divided into priority electronic medical source documents from health care providers and non-priority electronic medical source documents from health care providers.

35. A system as in claim 34, wherein the electronic medical source documents are divided into priority electronic medical source documents from health care providers assigned to the medical coder and priority electronic medical source documents from health care providers not assigned to the medical coder.

36. A system as in claim 35, wherein the electronic medical source documents are divided into non-priority electronic medical source documents from health care providers assigned to the medical coder and non-priority electronic medical source documents from health care providers not assigned to the medical coder.

37. A medical records processing system for integrating a medical document imaging system with a medical coding application, comprising:
a medical source document window configured to display a medical source document for a health care provider;
a hosting server, coupled to the medical source document window, having electronic storage to store the medical source document being viewed in the medical source document window; and
a coding window configured to capture information from the medical source document window and assist a medical coder in creating coded medical information from the medical source document that is viewed in the medical source document window.

38. A system as in claim 37, wherein the medical source document window further includes medical terminology and the medical terminology is able to be selected and the selection of the medical terminology enters the medical terminology into a search list.

39. A system as in claim 38, wherein the medical coder is able to perform a search based on the medical terminology in the search list and a medical code list will be provided.

40. A system as in claim 39, wherein the medical coder is able to select a medical code from the medical code list and associate that medical code with the medical source document.

41. A system as in claim 39, wherein the medical code list provides medical codes from a plurality of coding systems.

42. A system as in claim 37, further comprising a plurality of coding queues within the hosting server to which the medical source document is assigned based on a priority assigned to the medical source document.

43. A system as in claim 37, further comprising a networked interface through which a medical coder can access the medical source document and create coded medical information from the medical source document.

44. A system as in claim 37, further comprising a plurality of electronic output channels configured to transmit the coded medical information to the health care provider.

45. A system as in claim 37, further comprising a medical code validation module that checks the codes entered or selected by the medical coder to determine whether the medical codes are valid.

46. A system as in claim 37, further comprising an electronic question system that allows a doctor to view a question and the question includes a link to the medical source document to allow the doctor to review of the medical source document and respond.

47. A method for assisting a medical coder in processing medical records, comprising the steps of:
displaying a medical source document, containing medical terminology from a health care provider, in a medical source document window;
selecting medical terminology from the medical source document in the medical source document window;
copying the selected medical terminology to a coding window from the medical source document window;
searching for medical codes related to the medical terminology copied to the coding window;
allowing a medical coder to select a medical code representing an applied medical procedure for a patient from a medical codes list displayed to the medical coder as a result of the searching step, to created coded medical information;
sending coded medical information that has been created from the medical source document to a hosting server.

48. A method as in claim 47, wherein the medical coder is able to select a medical code from the medical code list and associate that medical code with the medical source document.

49. A method as in claim 47, further comprising the step of allowing the medical coder to enter supplemental medical terminology in addition to the selected medical terminology.

50. A method as in claim 47, further comprising the step of sending the coded medical information from the hosting server to the medical service provider.

51. A method as in claim 47, further comprising the step of providing medical codes from a plurality of coding systems in the medical codes list.

52. A method as in claim 47, further comprising the step of providing a plurality of coding queues within the hosting server to which the medical source document is assigned based on a priority of the medical source document.

53. A method as in claim 47, further comprising the step of accessing the medical source document and creating coded medical information from the medical source document through a networked interface.

54. A method as in claim 53, further comprising the step of accessing the medical source document and creating coded medical information from the medical source document through a network browser.

55. A method as in claim 47, further comprising the step of validating codes entered or selected by the medical coder to determine whether the medical codes are valid.
